(19) United States
(12) Patent Application Publication
(10) Pub. No.: US 2003/0156781 A1
(43) Pub. Date: Aug. 21, 2003

(54) Quantum domain relay

(76) Inventor: Boris Pavlov, Auckland (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/276,952

(22) PCT Filed: May 17, 2001
(86) PCT No.: PCT/IB01/01042

(30) Foreign Application Priority Data
May 17, 2000 (NZ) 504590

(51) Int. Cl. G02B 6/35

(52) U.S. Cl. 385/16

(57) ABSTRACT

The invention provides a quantum domain relay including at least three waveguides, each waveguide providing one degree of freedom to particles contained within the waveguide, a quantum well with one end of each waveguide connected to the quantum well, and a field of constant magnitude with is applied to the quantum well and the direction of which may be altered to direct particles entering the well through one waveguide to another waveguide.

### FIELD OF INVENTION

The present invention relates to a system and method for resonance manipulation of quantum currents through splitting.

### BACKGROUND

In recent years, there has been much interest in exploiting the wave nature of electrons to achieve interference effects in microelectronic structures. In a microelectronic system it is possible to build an entire device with active dimensions confined smaller than an electron's phase coherence length, i.e. 1 to 5 μm so that the phase of a electron wavefunction is preserved everywhere. Such a device is generally called a quantum structure.

A quantum structure, such as a thin epitaxial film of narrow bandgap material, sandwiched between wider bandgap material, limits electrons to two degrees of freedom in the file and is referred to as a 2D Quantum Well or merely a Quantum Well. When the movement of electrons is fisher constricted in another direction, leaving only one degree of freedom, the structure is called a Quantum Wire or Quantun Waveguide. One of the attributes of quantum wires or waveguides is the enhanced mobility of electrons in such structures caused by the reduction in scattering events resulting from one-dimensional confinement.

### SUMMARY OF INVENTION

In broad terms in one aspect the invention comprises a quantum domain relay including at least three quantum waveguides each providing one degree of freedom to any particles within the waveguide, a quantum well to which one end of each quantum waveguide is attached, and a field of constant magnitude, the direction of which may be altered to direct particles entering the well through one waveguide to another waveguide.

Preferably the quantum well is substantially circular.

Preferably the particles are electrons and the field is an electromagnetic field. Alternatively the particles may be photons. If the particles are photons then the field may be an acoustic field.

Preferably the quantum domain relay includes four quantum waveguides spaced at angles of about 0, 60, 180 and 300 degrees around the outside of the quantum well.

Preferably the manipulation of the particles is based on resonance properties of the domain defined by the quantum waveguides and quantum well and implemented in the constant magnitude field.

Preferably the magnitude of the field for the dimensionless Schrodinger equation is defined by the boundary conditions applied to the boundary of the quantum waveguides and quantum well. Ideally the boundary conditions are Neumann boundary conditions.

In broad terms in another aspect the invention comprises a quantum domain decision device including an input quantum waveguide and at least two output quantum waveguides arranged around a central well, in which a quantum current enters the well through the input quantum waveguide and is directed towards a selected output quantum waveguide by means of a constant electric field applied to the device.

In broad terms in another aspect the invention comprises a method for passing particles from an input quantum waveguide to an output quantum waveguide both attached at one end to a quantum well including the steps of, allowing particles to flow through the input waveguide into the quantum well, applying a field of constant magnitude to the quantum well and adjusting the direction of the field such that a path of low resistance is formed between the first waveguide and the other waveguide such that the particles flow along the path of low resistance.

Preferably the particles are electrons and the field is an electromagnetic field. Alternatively the particles may be photons and the field may be an acoustic field.

### BRIEF DESCRIPTION OF DRAWINGS

The invention is further described with reference to the accompanying drawings by way of example only and without intending to be limiting, wherein:

FIG. 1 shows a quantum domain relay of the invention;

FIG. 2 shows the quantum domain relay of the invention with an electromagnetic field applied forming a path of least resistance between two quantum waveguides; and

FIG. 3 shows the quantum domain relay of the invention with an electromagnetic field applied forming a path of least resistance between two quantum waveguides such that electrons entering through a waveguide not on the path of least resistance move towards one waveguide only.

### DETAILED DESCRIPTION

The description of the electron current through the quantum domain relay of the invention is a mathematical problem of electron transport in quantum networks. For quantum networks constructed on the interface of narrow-gap semiconductors the relevant scattering problem described by the multi-dimensional Schrodinger equation may be substituted by the corresponding problem on a one-dimensional linear graph with proper selfadjoint boundary conditions at the nodes. However the realistic choice of parameters in the boundary conditions of quantum domain relays of a general linear graph has not yet been defined. The parameters of the boundary conditions of quantum domain relays depend on the material used to form the quantum domain relay.

One possible solution is a design for a quantum domain relay using the one-dimensional graph which permits manipulating of quantum currents in resonance conditions. In this case resonance occurs when the Fermi level in the waveguides coincides with some resonance energy level in the quantum well and an approximate formula for the transmission coefficient from one quantum waveguide to another is derived. In the case of weak interaction between the quantum well and the waveguides the transmission coefficient is proportional to the product of values of the corresponding resonance eigenfunction of the inner problem at the points of contact, where an eigenfunction is an allowed wave function in the system of quantum mechanics. One design of quantum domain relay is a circular quantum well domain with four one-dimensional waveguides attached to it at 0, 60, 180 and 300 degrees. For the dimensionless Schrodinger equation

−Δψ+[V₀+εr cos (θ)]ψ=[λ+V₀]ψ 1

on the quantum well domain with Neumann boundary conditions at the boundary of the quantum well domain

$$\frac{\partial Ψ}{\partial n} {\vert}_{r = 1} = 0 \qquad 2$$

and the waveguides are attached as described above then the dimensionless magnitude ε of the governing electromagnetic field is chosen such that redirecting quantum current from one waveguide (attached at 0 degrees) to some other waveguide with access to the other waveguides blocked may be performed by adjusting the direction of the governing electromagnetic field. All of this takes place for a given value of the Fermi level λ+V₀ in the waveguides.

A similar problem occurs in a circular two dimensional quantum well with straight waveguides attached to it on the boundary in the same positions as mentioned above. Assuming that the homogeneous Dirichlet boundary conditions are satisfied on the whole boundary of the quantum well and the waveguides a constant electromagnetic field may be applied to the quantum well. The direction of this constant electromagnetic field acts to direct electrons entering through the waveguide at 0 degrees to some other waveguide whilst blocking access to the other waveguides. As the direction of the applied electromagnetic field is changed so is the path of least resistance the electrons are directed to other waveguides.

More generally in the resonance case the contact points for the quantum waveguide and the intensity of the electromagnetic filed are chosen so that switching of the electron current from one direction to another may be manipulated by adjusting the direction of the electromagnetic field only.

The problem of switching the direction of the current of the electrons is solved in an electromagnetic field intensity can be found such that some zeros of the resonance eigenfunction on the boundary of the quantum well satisfy the condition

$$\frac{\vert {b}_{s} - {b}_{i} \vert}{\vert {b}_{s} - {b}_{r} \vert} = 2 \qquad 3$$

In this case quantum waveguides may be attached to the quantum well at points a₁, a₂, a₃ . . . aₙ such that |a₂−a₃|=|a₃−a₄|= . . . |aₙ₋₁−aₙ|=|bₛ−bᵣ| and the direction of the electromagnetic field vector may be chosen such that some zeros of the corresponding resonance eigenfunction coincide with either a₂, a₃ or a₃, a₄ or a₂, a₄ or . . . aₙ₋₁, aₙ, and at the same time the values of the normalised resonance eigenfunction for the points of contact in question are not equal to zero.

For the case with four quantum waveguides it was found that the waveguides should be positioned at 0, 60, 180 and 300 degrees around the quantum well.

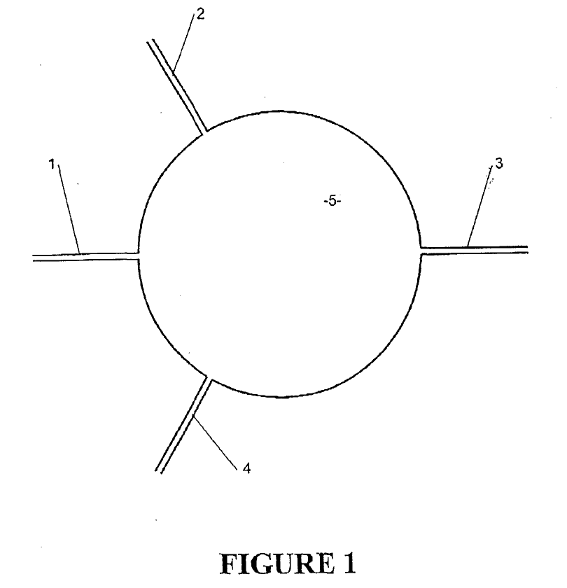

FIG. 1 shows a quantum domain relay of the invention. The quantum domain relay comprises four waveguides 1, 2, 3, 4 and a central quantum well 5. The waveguides are spaced with waveguide 1 at 0 degrees, waveguide 2 at 60 degrees, waveguide 3 at 180 degrees and waveguide 4 at 300 degrees around the outside of quantum well 5. All particles enter the quantum domain relay through waveguide 1. Depending of the direction of the field applied to quantum well 5 the particles may exit through any of the other three waveguides. If the particles are electrons then the field applied to quantum well 5 is an electromagnetic field and if the particles are photons the field applied to quantum well 5 may be an acoustic field.

The quantum domain relay may be constructed on the interface of an electrolyte and a narrow-gap semiconductor. The waveguides are usually constructed by etching narrow channels where the molecules of the electrolyte form a conducting chain. Quantum wells may be formed on the surface of the semiconductor by epitaxy. Other methods for forming the waveguides include the formation of split-gate structures, mesa etching and focused ion-beam damage introduction.

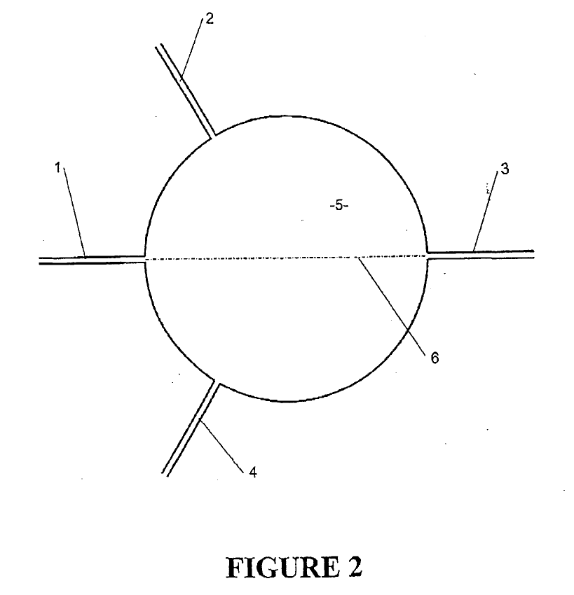

FIG. 2 shows the quantum domain relay of the invention with an electromagnetic field applied forming a path of least resistance between two quantum waveguides. In this case the applied electromagnetic field has formed a path of least resistance between waveguides 1 and 3. All the electrons will follow the path of least resistance illustrated by dashed line 6 and flow from waveguide 1 to waveguide 3. The magnitude of the applied electromagnetic field is constant and dependent on the Fermi level as describe above.

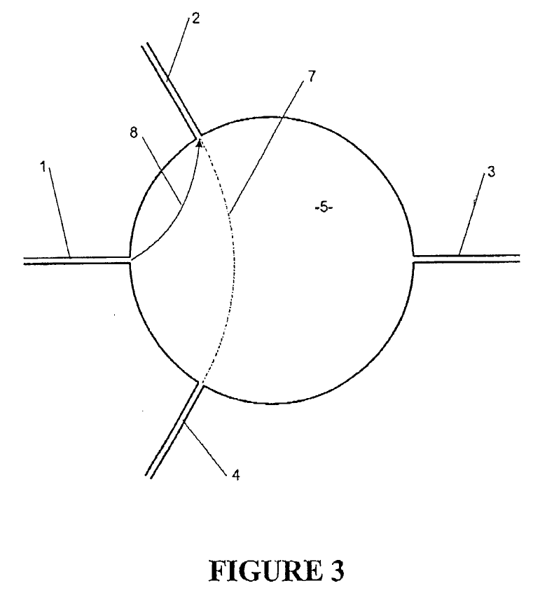

FIG. 3 shows the quantum domain relay of the invention with an electromagnetic field applied forming a path of least resistance. The path of least resistance, illustrated by dashed line 7, between quantum waveguides 2 and 4 is such that electrons entering through waveguide 1, not on the path of least resistance, move towards waveguide 2 only following arrow 8. Electrons entering through waveguide 1 flow with the electromagnetic field towards waveguide 2. Because electrons flow with the applied electromagnetic field access to waveguides 3 and 4 is effectively blocked. It is also possible to apply the electromagnetic field from waveguide two to waveguide 4 so that the electrons entering the quantum well 5 at waveguide 1 exit through waveguide 4.

The quantum domain relay of the invention has many applications and advantages. Uses include quantum computing, coding and information processing. The quantum domain relay of the invention lends itself to triadic logic using three states instead of the binary two. The quantum domain relay uses a constant electromagnetic field with adjustable direction to determine the path which the electrons follow and has low energy requirements makings its use efficient.

The foregoing describes the invention including a preferred form thereof. Alterations and modifications as will be obvious to those skilled in the art are intended to be incorporated within the scope hereof as defined in the accompanying claims.

1. A quantum domain relay including:
at least three quantum waveguides each providing one degree of freedom to any particles within the waveguide,
a quantum well to which one end of each waveguide is attached, and
a field of constant magnitude the direction of which may be altered to direct particles entering the well through one waveguide to another waveguide.

2 A quantum domain relay according to claim 1 where the quantum well allows particles within the well two degrees of freedom of movement.

3. A quantum domain relay according to claim 1 or claim 2 where the particles are electrons and the field is an electromagnetic field.

4. A quantum domain relay according to claim 1 or claim 2 where the particles are photons.

5. A quantum domain relay according to any one of claims 1 to 4 where the waveguides are arranged around the sides of the quantum well such that when it is desired for particles to move from one selected waveguide to another selected waveguide the direction of the field may be chosen so that some zeros of the corresponding resonance eigenfunction coincide with the non-selected waveguides but no zeros of the corresponding resonance eigenfunction coincide with the selected waveguides.

6. A quantum domain relay according to any one of claims 1 to 5 where the magnitude of the field is defined by boundary conditions on the dimensionless Schrodinger equation applied to the boundary of the quantum waveguides and the quantum well.

7. A quantum domain relay according to claim 6 where the boundary conditions are Neumann boundary conditions.

8. A quantum domain relay according to any of claims 1 to 7 in which the quantum well is substantially circular.

9. A quantum domain relay according to any of claims 1 to 9 where the quantum domain relay includes four quantum waveguides spaced at angles of about 0, 60, 180 and 300 degrees around the sides of the quantum well.

10. A quantum decision device including an input quantum waveguide, at least two output quantum waveguides arranged around a quantum well, in which a quantum current enters the well through the input waveguide and is directed towards a selected output quantum waveguide by means of a constant electric field applied to the device.

11. A quantum decision device according to claim 10 where the quantum well allows particles within the well two degrees of freedom of movement.

12. A quantum decision device according to claim 10 or claim 11 where the particles are electrons and the field is an electromagnetic field.

13. A quantum decision device according to claim 10 or claim 11 where the particles are photons.

14. A quantum decision device according to any one of claims 10 to 13 where the waveguides are arranged around the sides of the quantum well such that when it is desired for particles to move from one selected waveguide to another selected waveguide the direction of the field may be chosen so that some zeros of the corresponding resonance eigenfunction coincide with the non-selected waveguides but no zeros of the corresponding resonance eigenfunction coincide with the selected waveguides.

15. A quantum decision device according to any one of claims 10 to 14 where the magnitude of the field is defined by boundary conditions on the dimensionless Schrodinger equation applied to the boundary of the quantum waveguides and the quantum well.

16. A quantum decision device according to claim 15 where the boundary conditions are Neumann boundary conditions.

17. A quantum decision device according to any one of claims 10 to 16 in which the quantum well is substantially circular.

18. A quantum decision device according to any of claims 10 to 17 where the quantum decision device includes four quantum waveguides spaced at angles of about 0, 60, 180 and 300 degrees around the sides of the quantum well.

19. A method for passing particles from an input quantum waveguide to an output quantum waveguide both attached at one end to a quantum well including the steps of:
allowing the particles to flow through the input waveguide into the quantum well,
applying a field of constant magnitude to the quantum well, and
adjusting the direction of the field such that a path to low resistance is formed between the input waveguide the and the output waveguide such that particles flow along the path of low resistance.

20. A method for passing particles from an input quantum waveguide to an output quantum waveguide according to claim 19 where the particles are electrons and the field is an electromagnetic field.

21. A method for passing particles from an input quantum waveguide to an output quantum waveguide according to claim 19 where the particles are photons.

22. A method for passing particles from an input quantum waveguide to an output quantum waveguide according to any one of claims 19 to 21 where the magnitude of the field is defined by boundary conditions of the dimensionless Schrodinger equation applied to the boundary of the quantum waveguides and the quantum well.

23. A method for passing particles from an input quantum waveguide to an output quantum waveguide according to any one of claims 19 to 22 where the path formed between the two waveguides is a path of least resistance.

24. A method for passing particles from an input quantum waveguide to an output quantum waveguide according to any one of claims 19 to 22 where the path formed between the two waveguides is a path of low resistance but not the path of least resistance.

25. A method for passing particles from an input quantum waveguide to an output quantum waveguide according to any one of claims 19 to 24 where the direction of the field may be changed to select different output waveguides.
